(19) United States
(12) Patent Application Publication
(10) Pub. No.: US 2018/0218452 A1
(43) Pub. Date: Aug. 2, 2018

(54) SYSTEM, METHOD AND APPARATUS FOR SECURE IMPLEMENTATION OF REAL-TIME, REVEALED-RISK, INSURANCE PRICING AND DRIVING BEHAVIOR FEEDBACK

(71) Applicant: Commute Safety, LLC, Lady Lake, FL (US)

(72) Inventors: Randall L. Guensler, Atlanta, GA (US); Jennifer Ogle, Clemson, SC (US); John J. Mackey, Bayville, NY (US); Robert C. McElroy, Lady Lake, FL (US); Kenneth G. Geraghty, Tinton Falls, NJ (US); Christopher J. Brogan, Bayville, NY (US)

(21) Appl. No.: 15/433,791

(22) Filed: Feb. 15, 2017

Related U.S. Application Data
(60) Provisional application No. 62/388,982, filed on Feb. 16, 2016.

(51) Int. Cl. G06Q 40/08

(52) U.S. Cl. CPC G06Q 40/08

(57) ABSTRACT

A method and system are provided for providing insurance pricing. The method includes acquiring data associated with a vehicle, a roadway, an environment, acquiring data regarding the driver, encrypting the data, transmitting the data, and determining a risk based on the data associated with the vehicle, the roadway, the environment and the driver, and determining an insurance premium price based on the risk, wherein the insurance premium price is in units of price per unit time or price per unit distance.

This application claims priority under 35 U.S.C. § 119(e) to U.S. Provisional Patent Application No. 62/388,982 which was filed in the U.S. Patent and Trademark Office on Feb. 16, 2016, the entire content of which is incorporated herein by reference.

### FIELD

The present disclosure generally relates to a method, apparatus and system for pricing of driver and vehicle insurance, and more particularly, to a method, apparatus and system for pricing of driver and vehicle insurance based on revealed risk and driver behavior.

### BACKGROUND

Assessing insurance premiums for drivers and vehicles accurately and competitively requires access to data in order to determine appropriate insurance premium pricing. The relevant data typically includes demographics of the driver, location of vehicle operation, traffic conditions, road conditions, environmental conditions, the driver's driving record and accident history, and the condition of the vehicle.

### SUMMARY

According to an aspect of the present disclosure, a method is provided that includes acquiring data associated with a vehicle, a roadway, an environment and a driver, encrypting the data, transmitting the data, determining a risk based on the data associated with the vehicle, the roadway, the environment and the driver, and determining an insurance premium price based on the risk that is determined, wherein the insurance premium price is in units of price per unit time or price per unit distance.

According to another aspect of the present disclosure, an apparatus is provided which includes a memory, a processor configured to acquire data associated with a vehicle, a roadway, an environment and a driver, encrypt the data, transmit the data, determine a risk based on the data associated with the vehicle, the roadway, the environment and the driver, and determine an insurance premium price based on the risk, wherein the insurance premium price is in units of price per unit time or price per unit distance.

According to another aspect of the present disclosure, a system is provided which includes a vehicle, a display device, a server, a database, and a processor configured to acquire data associated with the vehicle, a roadway, an environment and a driver, encrypt the data, transmit the data, determine a risk based on the data associated with the vehicle, the roadway, the environment and the driver, and determine an insurance premium price based on the risk, wherein the insurance premium price is in units of price per unit time or price per unit distance.

### BRIEF DESCRIPTION OF THE DRAWINGS

The above and other aspects, features and advantages of the present disclosure will become more apparent from the following detailed description, when taken in conjunction with the accompanying drawings, in which:

FIG. 1 is a block diagram of an electronic device in a communication network, according to an embodiment of the present disclosure;

FIG. 2 illustrates a system for determining real-time insurance premium pricing, according to an embodiment of the present disclosure;

FIG. 3 illustrates a system for determining real-time insurance premium pricing, according to another embodiment of the present disclosure;

FIG. 4 illustrates roadway polygons, according to an embodiment of the present disclosure;

FIG. 5 illustrates a roadway map and average vehicle speeds, according to an embodiment of the present disclosure;

FIG. 6 is a graph illustrating acceleration, speed and activity time of a vehicle, according to an embodiment of the present disclosure.

FIG. 7 is a map illustrating accident data, driver data and roadway data, according to an embodiment of the present disclosure;

FIG. 8 is a map illustrating alternative driving routes, according to an embodiment of the present disclosure;

FIG. 9 is a screenshot of a display which displays vehicle location, insurance premium rate and insurance price for a current trip, according to an embodiment of the present disclosure; and

FIG. 10 is screenshot of a display which displays vehicle speed and current vehicle location speed limit, according to an embodiment of the present disclosure.

### DETAILED DESCRIPTION

The present disclosure will now be described more fully hereinafter with reference to the accompanying drawings, in which embodiments of the present disclosure are shown. This disclosure may, however, be embodied in many different forms and should not be construed as limited to the embodiments set forth herein. Rather, these embodiments are provided so that this disclosure will be thorough and complete, and will fully convey the scope of the device and method to those skilled in the art. Like reference numbers refer to like elements throughout.

It will be understood that when an element is referred to as being “connected” or “coupled” to another element, it may be directly connected or coupled to the other element or intervening elements may be present. In contrast, when an element is referred to as being “directly connected” or “directly coupled” to another element, there are no intervening elements present. As used herein, the term “and/or” includes, but is not limited to, any and all combinations of one or more of the associated listed items.

It will be understood that, although the terms first, second, and other terms may be used herein to describe various elements, these elements should not be limited by these terms. These terms are only used to distinguish one element from another. For example, a first signal may be referred to as a second signal, and, similarly a second signal may be referred to as a first signal without departing from the teachings of the disclosure.

The terminology used herein is for the purpose of describing particular embodiments only and is not intended to limit the present device and method. As used herein, the singular forms “a”, “an” and “the” are intended to include the plural forms as well, unless the context clearly indicates otherwise. It will be further understood that the terms “comprises” and/or “comprising,” or “includes, but is not limited to” and/or “including, but not limited to” when used in this specification, specify the presence of stated features, regions, integers, steps, operations, elements, and/or components, but do not preclude the presence or addition of one or more other features, regions, integers, steps, operations, elements, components, and/or groups thereof.

Unless otherwise defined, all terms (including, but not limited to technical and scientific terms) used herein have the same meanings as commonly understood by one of ordinary skill in the art to which the present device and method belongs. It will be further understood that terms, such as those defined in commonly used dictionaries, should be interpreted as having meanings that are consistent with their meaning in the context of the relevant art and/or the present description, and will not be interpreted in an idealized or overly formal sense unless expressly so defined herein.

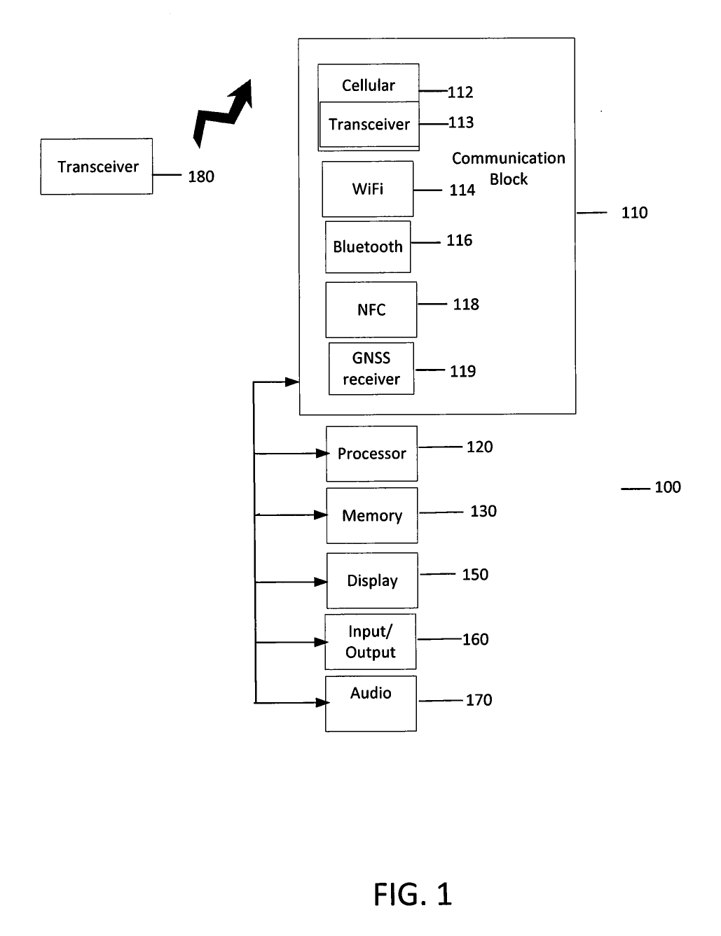

FIG. 1 is a block diagram of an electronic device in a network environment, according to an embodiment of the present disclosure.

Referring to FIG. 1, an electronic device 100 includes, but is not limited to, a communication block 110, a processor 120, a memory 130, a display 150, an input/output block 160, an audio block 170 and a wireless transceiver 180. The wireless transceiver 180 may be included in a WiFi access point, a smart phone or cellular base station and includes, but is not limited to, a wireless transmitter and receiver.

The electronic device 100 includes a communication block 110 for connecting the device 100 to another electronic device or a network for communication of voice and data. The communication block 110 provides general packet radio service (GPRS), enhanced data rates for GSM evolution (EDGE), cellular, wide area, local area, personal area, near field, device to device (D2D), machine to machine (M2M), satellite, enhanced mobile broad band (eMBB), massive machine type communication (mMTC), ultra-reliable low latency communication (URLLC), narrowband Internet of things (NB-IoT) and short range communications. The functions of the communication block 110, or a portion thereof including a transceiver 113, may be implemented by a chipset. In particular, the cellular communications block 112 provides a wide area network connection through terrestrial base transceiver stations or directly to other electronic devices, using technologies such second generation (2G), GPRS, EDGE, D2D, M2M, long term evolution (LTE), fifth generation (5G), long term evolution advanced (LTE-A), code division multiple access (CDMA), wideband code division multiple access (WCDMA), universal mobile telecommunications system (UMTS), wireless broadband (WiBro), and global system for mobile communication (GSM). The cellular communications block 112 includes, but is not limited to, a chipset and the transceiver 113. The transceiver 113 includes, but is not limited to, a transmitter and a receiver. The wireless fidelity (WiFi) communications block 114 provides a local area network connection through network access points using technologies such as IEEE 802.11. The Bluetooth communications block 116 provides personal area direct and networked communications using technologies such as IEEE 802.15. The near field communications (NFC) block 118 provides point to point short range communications using standards such as ISO/IEC 14443. The communication block 110 also includes a GNSS receiver 119. The GNSS receiver 119 supports receiving signals from a satellite transmitter.

The electronic device 100 may receive electrical power for operating the functional blocks from a power supply, including, but not limited to, a battery. The wireless transceiver 180 may be a part of a WiFi access point or a terrestrial base transceiver station (BTS) (such as a cellular base station) and include a radio frequency transmitter and receiver conforming to third generation partnership project (3GPP) standards. The wireless transceiver 180 may provide data and voice communications services to users of mobile user equipment (UE). In the present disclosure, the term “UE” may be used interchangeably with the term “electronic device”.

The processor 120 provides application layer processing functions required by the user of the electronic device 100. The processor 120 also provides command and control functionality for the various blocks in the electronic device 100. The processor 120 provides for updating control functions required by the functional blocks. The processor 120 may provide for coordination of resources required by the transceiver 113 including, but not limited to, communication control between the functional blocks. The processor 120 may also update the firmware, databases, lookup tables, calibration method programs and libraries associated with the cellular communications block 112 or WiFi block 114. An image sensor connected to processor 120 captures still and moving images inside and out side of a vehicle.

The memory 130 provides storage for device control program code, user data storage, application code and data storage. The memory 130 may provide data storage for the firmware, libraries, databases, lookup tables, algorithms, methods, channel estimation parameters, and calibration data required by the cellular communications block 112 or WiFi block 114. The program code and databases required by the cellular communications block 112 or WiFi block 114 may be loaded into local storage from the memory 130 upon device boot up. The cellular communications block 112 or WiFi block 114 may also have local, volatile and non-volatile memory for storing the program code, libraries, databases, calibration data and lookup table data.

The display 150 may be a touch panel, and may be embodied as a liquid crystal display (LCD), organic light emitting diode (OLED) display, active matrix OLED (AMOLED) display, and the like. The input/output block 160 controls the interface to the user of the electronic device 100. The audio block 170 provides for audio input and output to/from the electronic device 100. The audio block 170 captures audio inside and outside of a vehicle.

The display 150 may be used to provide insurance premium pricing, roadway conditions, environmental conditions and driver related data to a driver of a vehicle.

The wireless transceiver 180 may be included in an access point or base station that is used to receive, transmit or relay wireless signals. The wireless transceiver 180 may facilitate communication with the electronic device 100 by sending, receiving, and relaying data communication signals to and from the electronic device 100. The electronic device 100 may be connected to a network through the wireless transceiver 180. For example, the wireless transceiver 180 may be an access point, a cell tower, a wireless router, an antenna, multiple antennas, or a combination thereof being used to send signals to, or receive signals from, the electronic device 100, such as a smartphone. The wireless transceiver 180 may relay the wireless signals through the network to enable communication with other electronic devices 100 such as user equipment (UE), servers or a combination thereof. The wireless transceiver 180 may be used to transmit data associated with a vehicle, a roadway, an environment and a driver.

According to an embodiment of the present disclosure, a method, apparatus and system is provided to determine risk and insurance premium pricing in real-time as a function of revealed driver risk, where risk is determined as a function of: 1) driver, passenger, and household demographics, 2) vehicle performance characteristics, 3) real-time vehicle and engine operating conditions, 4) roadway and intersection design configurations and operating conditions, and 5) environmental conditions. An onboard computer system, which may be based in (or on) the vehicle, driver, or passenger in the form of fixed computing device, a portable computing device, smartphone app, or any other processing unit, collects and encrypts vehicle activity and driver behavior data, collects and encrypts customized revealed-risk pricing algorithms, and facilitates the interaction of the acquired data with the algorithms by mutual permission of the customer and the insurance carrier to implement real-time insurance premium pricing. The onboard vehicle computer software employs remotely-updatable polygon fields (bounding discrete transportation facilities) to encode roadway and intersection design configurations and driver behavior. A GNSS 119, GPS receiver or other location based service such as cellular triangulation of WiFi positioning determines date, time, and vehicle location. Vehicle performance characteristics are derived from a database using the vehicle identification number. The on board diagnostic (OBD)/MAY interface provides on-road vehicle operating conditions, which are associated in real-time with roadway data using the current date, time and location information. Positive driver identification (ID) may be determined by subscriber identity module (SIM) cards, smart-keys, RFID, or other means. Passenger counts (number of passengers in vehicle) are determined by seatbelt sensors, image processing, biometrics, infrared, or other means. Windshield wiper sensors and temperature sensors determine environmental conditions. The present system and method also communicates determined risk and insurance premium price effect by risk-element to a driver for the purposes of affecting changes in driver behavior. The present system and method also collects, transmits, consolidates, and evaluates vehicle and engine activity data and collision event data to continuously refine the risk based insurance premium pricing algorithms and to provide actuarial insurance rate justification. The present system and method transmits remote traffic signal intersection detection information to a driver using a driving behavior application via a data collection unit installed at traffic signalized intersections. The ability to detect traffic signal sequences may improve driver behavior and improve safety and reduce emissions.

According to an embodiment of the present disclosure, a system and method is provided which determines insurance premiums on a cost per distance (ex. mile) or cost per unit time (ex. day, hour) basis as a function of real-time, revealed driver risk, where risk is assessed as a function of where, when, and how a vehicle is operated, and by whom. An onboard computing system combines encrypted data generated by the vehicle connected to a network and associated with the vehicle operator, with encrypted risk algorithms associated with the insurance provider to calculate real-time insurance premiums as a function of revealed risk. A variety of onboard computing systems are provided, where such systems may be originally installed by the vehicle manufacturer or added to the vehicle after manufacture. Additional computing devices may be provided by the driver, passenger or third party in the form of a portable computing device, smartphone app, or other processing unit. Revealed risk is statistically-derived as a function of driver, passenger, and household demographics, vehicle performance characteristics, real-time vehicle and engine operating parameters, roadway and intersection design configurations and operating conditions, and environmental conditions. The insurance premium pricing is determined using algorithms developed through an actuarial analysis of the data transmitted from vehicles and operators executing the present system and method.

An onboard vehicle computer may employ remotely-updatable polygon fields (where polygons are established such that they bound discrete and encrypted transportation facility links) to connect real-time vehicle operating conditions to roadway design and prevailing traffic condition data. The GPS receiver provides date, time, and vehicle location (latitude/longitude), allowing on-road vehicle operation to be associated with a roadway link or intersection polygon. Each polygon is associated with specific roadway and intersection design configuration and current operating conditions (ex. average speed, speed/acceleration distribution, acceleration noise, traffic density, etc.) The current prevailing traffic conditions for any roadway are transmitted using secure encryption on a polygon-by-polygon basis as they are received from government-operated advanced traffic management systems, third-party providers, or through the transmission of data from a sufficient number of vehicles participating in the insurance pricing system. The OBD/MAY interface provides access to the vehicle operating conditions. The information indicating vehicle operating conditions is encrypted and transmitted to a server within the system to be correlated in real-time with roadway data, so that vehicle performance relative to the prevailing vehicle activity may be compared (speed differentials relative to other traffic or historical averages are identified in this manner). Vehicle operation may be linked in real time directly to roadway and intersection design parameters and prevailing traffic and environmental conditions.

Insurance premium pricing algorithms for the vehicle insurance are developed through the actuarial analysis of encrypted data transmitted by all vehicles participating in the pricing program (and other data obtained through research studies, third party providers or other commercial operations). The resulting insurance premium pricing plans are designed to price insurance on a cost per unit distance or cost per unit time basis (at the insurer's option) and is a function of expected cash outlays for the insurer resulting from cost incurring events. Factors included in determining insurance premium pricing include the probability of vehicle collision occurrence by collision type, expected value of vehicle damage, expected value of third party damage and other cost liabilities. Additional factors included in determining insurance premium pricing are the insured's covered household or commercial fleet and range of on-road vehicle activity. The insurance premium pricing is based upon revealed risk as determined through the analysis of the data sets comprising data associated with a vehicle, a roadway, an environment and a driver as described in the present disclosure. The insurance premium pricing method may be implemented by placing the statistically derived pricing algorithms in the onboard vehicle computer, remote server, aftermarket installed computer, or driver's portable computing device such as a smartphone or tablet for calculation of the real-time insurance premium rate. The system and method automates the process of statistical analysis and automates the creation of data subsets for use in more advanced statistical analysis. Hence, encrypted data collected by vehicles during real-time pricing serve as additional input data for use in the ongoing refinement of insurance premium price structures and actuarial insurance rate justification.

The present system and method also communicates estimated risk and insurance premium price effect by individual risk element to the driver for the purpose of affecting changes in driver behavior. This system and method provides the simultaneous benefit of informing the driver of their current insurance rate, educating the driver about the relationship between monitored high-risk driver behavior (ex. speeding, hard acceleration, over-revving engine, etc.) and insurance premium rate, and providing an influence designed to modify driver behavior and improve overall system safety and efficiency. The present system and method informs the insurer of the same events as the driver and policy holder. Event and other collected data may be transmitted securely using an encrypted format.

The cost per unit distance or cost per unit time insurance premium rate for any vehicle is calculated in real-time by an in vehicle computer, remote server, personal computing device or remote server in accordance with preprogrammed insurance premium pricing algorithms that are derived from an ongoing actuarial analyses. The present system and method provides multiple advantages in that monitored vehicle activity is used to assess the insurance premium in real-time, monitored data are processed and transmitted with encryption to the insurance provider (or contractor to the insurance provider) for use in continual refinement of insurance premium pricing algorithms. The insurance premium pricing algorithms are updated and encrypted on a regular basis as new cause-effect relationships and surrogate variables (such as percentage of operating time over the speed limit by road type, acceleration noise, stop line acceleration rate, mid-block rapid deceleration rate, etc.) are revealed through ongoing actuarial analysis collected by the system and as the insurance premium price structures are approved by the regulatory community. For example, differentials between driver speed and posted speed limit are highly correlated with traffic ticket history and may be used as a surrogate measure in insurance premium pricing algorithms.

According to an embodiment of the present disclosure, a detailed actuarial analysis of all vehicles participating in the insurance premium pricing program (and other encrypted data collected or procured through research studies or commercial applications), insurance providers may continuously refine risk-based insurance pricing. The present system and method provides the encrypted data and the data structures that allow for the implementation of automated statistical analysis of the comprehensive analytical database as the system and method continuously appends new vehicle activity data enabling actuarial staff to continuously refine risk-based premiums, identify direct and surrogate variables for use in insurance premium pricing algorithm development, and provide actuarial insurance rate justification for premium pricing algorithms.

According to an embodiment of the present disclosure, vehicle operation is continuously monitored by the system and is linked directly to driver and vehicle characteristics, roadway design parameters, actual on-road operating conditions, collision histories for the roadway facilities traversed, and environmental conditions. Further, all vehicles executing the present system and method will directly reveal the specific conditions that were associated with any vehicle collision that occurred while the vehicle was monitored (where the collision is identified through accelerometer or IMU data or is reported to insurers via an insurance claim). For example approximately 10% of monitored vehicles may be involved in a collision event each year. Providing still and moving images captured at the time of a collision may determine collision fault, detect fraud, and provide data for insurance premium pricing. By automating the process of statistical analysis (descriptive statistics, cross-tab analysis, regression tree analysis, etc.) and by automating the process of creating encrypted data subsets for more advanced statistical techniques (such as logit and probit models designed to assess the potential contributions of specific variables to the probability of collision occurrence). The resulting premium pricing plans price insurance on a cost per unit distance or cost per unit time basis (at the insurer's option) as a function of expected cash outlays and liabilities for the insurer (probability of collision occurrence by collision type and expected value of damage function), given the insured's covered household or commercial fleet and range of on-road vehicle activity. The insurance premium pricing is based upon revealed risk as defined through the above-described analysis of extremely large data sets (collision histories and on-road operating histories). Hence, the insurance premium pricing more accurately reflects the risk of driving using information including driver characteristics, driver interaction with the vehicle, trip length, conditions under which the vehicle is operated, prevailing traffic conditions, prevailing environmental conditions, etc. By applying advanced statistical analysis techniques to the data amassed by the system, revealed risk may be quantified. Hence, the system may provide ongoing actuarial justification of vehicle insurance for approval by state regulatory authorities. Encrypting the data used in the system provides enhanced security against data breech and hacking.

The insurance premium pricing algorithms estimate relative collision risk and expected value of collision damage (personal and property) as a function of the correlations and interactions between the following variables: driver demographics, household demographics, driver experience, vehicle performance characteristics, vehicle and engine operating parameters, roadway and intersection design configurations, roadway and intersection operating conditions, and environmental conditions. The system and method determines direct pricing of insurance premiums based on risk using encrypted algorithms derived through actuarial analyses of historic collision, vehicle, roadway, operations, and other data applied to real-time conditions. Variables used to determine insurance premiums may be monitored in real time, such as vehicle operating conditions (monitored by onboard engine and vehicle monitors), prevailing traffic conditions (monitored through external sources), and environmental conditions (from environmental sensors), or may be fixed in time, such as roadway design parameters (stored in a database and accessible in real-time in order to correlate with vehicle position) allowing the insurance premium pricing system and method to be implemented by loading the statistically-derived, encrypted pricing algorithms into memory storage in the onboard computer for determination of the real-time insurance premium rate. The present system and method better differentiates between high-risk and low-risk drivers within the same demographic group that currently pay the same insurance premium rates.

The onboard vehicle computer hardware and software system may include a CPU, encrypted data storage, global positioning system (GPS) receiver, an interface to the onboard diagnostics system (OBD/MAY) or direct connection to engine control systems, a set of input/output lines to connect to external sensors, cameras, a communications port (e.g. RS-232, CAN or USB) for integrating environmental sensors, and a means of transmitting and receiving encrypted data from remote systems including satellite, cellular, WAN, WiFi, WLAN, mesh, ad-hoc vehicle-to-vehicle, or other electronic means. The onboard vehicle computer system may be installed as a separate unit in an aftermarket scenario, or may be integrated into the vehicle by the original equipment manufacturer for use in controlling driver behavior encrypted data sets.

The present system and method employs remotely-updatable polygon fields, where the polygon fields are established such that they bound discrete design-related and operations-related transportation facility links and where the entire set of polygons represents the system of roads upon which the vehicle operates. Polygon fields may be loaded and updated on demand as a function of vehicle position so that the vehicle may move seamlessly from city-to-city. For example, the road transportation system in Atlanta, Ga., is currently represented by approximately 16,000 polygons. The GPS receiver provides date, time, and vehicle location (latitude/longitude) enabling vehicle operation to be associated with a roadway link polygon (using a standard point-in-polygon position test for latitude and longitude) or to off-network activity.

Each polygon may be associated with specific roadway and intersection design configurations and operating conditions. With respect to roadway design parameters, the database includes a pre-coded set of polygon data provided from the state or regional roadway characteristics database, and includes such elements as: road segment length, number of lanes, lane width, shoulder width, roadway curvature, 85th percentile speed, intersection channelization, adjustment of weave and gore areas, traffic control, etc. The operating characteristics associated with each polygon (average vehicle speeds, speed/acceleration distribution, acceleration noise, traffic density, etc.) are derived from external data sources (e.g. government agencies that operate traffic management centers, cellular service providers, or other third party data providers), or by the system itself when sufficient amount of vehicle data is provided by participants executing the present system and method. The OBD/MAY interface provides access to the vehicle and engine operating conditions, correlated in real-time with roadway data, so that vehicle performance relative to prevailing vehicle activity may be compared (speed differentials relative to other traffic may be identified in this manner). Vehicle performance specifications are derived from a database associated with the vehicle identification number (horsepower, body style, options, etc.). Positive driver identification and authentication is determined by RFID, biometric or other means. Passenger counts may be based on seatbelt sensors, seat weight sensors, ultrasonic sensors and recorded images inside the vehicle. Windshield wiper sensors and temperature sensors may determine environmental conditions. The point-in-polygon system associates vehicle position with the applicable roadway link or intersection design and operating parameters for use in real-time insurance premium pricing.

The present system and method integrates the above-mentioned data elements into an encrypted (noted) file for transmission over a communications system to a remote host or server. Upon receipt at the server, the data is decrypted to re-structure the ASCII or other data format tables of disaggregate vehicle activity. Each time period of vehicle activity is represented by a data record (linked to previous and future data records by a date and time stamp and vehicle identification number) which includes date, time, speed, position, road polygon ID, driver identification, internal and external still and video images captured by in vehicle cameras or portable device cameras, and relevant vehicle and engine operating parameters (such as passenger load, seatbelt use, windshield wiper activation, braking signal, engine speed, manifold pressure, percent load, etc.). Because each polygon is associated with a set of specific design criteria that changes infrequently, the design specifications present on the vehicle system do not need to be transmitted with the other data, but may be added to the data stream upon decryption of the transmitted data and polygon identification number when the data reaches the server.

The polygon data stored onboard the vehicle remains static until commanded to change by a communication event. The data associated with each roadway polygon need only be updated when roadway design parameters or on-road operating conditions change. Hence, the system and method includes a message structure that communicates only the new encrypted data that needs to be updated (polygon identifier, data element identifier, and data element value) for each polygon field. The present system and method updates the polygon data as needed to reduce encrypted transmission message size and cost. Wide area broadcasting of encrypted transmission of polygon changes by geographic sub-region will further reduce communications requirements.

The present system and method includes a secure server on the Internet that allows designated state and regional department of transportation officials (with proper login authority and authentication) to change the design parameters associated with specific roadways when roadway improvements are made and also allows officials to designate new school and temporary construction zones (with reduced speed limits). A supervisory system operator is responsible for reviewing and confirming all such changes.

Roadway design parameters may also be adjusted when monitored disaggregate vehicle activity encrypted data indicates that the roadway links are not coded properly. For example, when the monitored 85th percentile speed differs significantly from the value encoded within a roadway polygon, the value is changed and a message is generated and transmitted to a designated transportation official to indicate that the difference was recorded and changed. The system and method may also update intersection design configuration data (presence of left turn bays, signal timing plans, presence of stop signs, etc.) as differences between coded values and monitored data from large numbers of vehicles executing the present system and method are determined and recorded.

A visual graphic and text display, and audible output alert may provide feedback to the vehicle driver of the primary vehicle and engine operating parameters that most affect real-time insurance premium rates, including parameters such as speed vs. speed limit, linear acceleration rate, angular acceleration rate, jerk, engine speed, throttle and brake dither, etc. The visual and text display and audible output may allow the driver to see or hear which factors contribute the most to the insurance premium rate. The present system and method simultaneously serves as a driver training tool by identifying high-risk driver behavior and providing an incentive to modify driver behavior. A website with driver or user login and password protection may provide another means for an insured driver or a user with supervisory control over the driver to examine, post-hoc, those variables that are contributing most to their insurance premium rate. A set of menus allow the driver or user to identify means to reduce their insurance premium rate by identifying modifiable driver behavior elements, or by selecting alternative trip destinations, routes, and travel times. An interactive trip-planning website, including: distance to destination vs. distance to alternative destinations, roadway and intersection design configurations, roadway operating characteristics, roadway collision histories, etc. Users such as parents of drivers may determine the in-vehicle and secured Internet feedback systems of the present system and method particularly useful in educating young drivers and reducing the risk of collision events. Users such as supervisors of fleet vehicle drivers may determine the in-vehicle and secured Internet feedback systems of the present system and method particularly useful in educating fleet drivers on how to modify driving behavior in order to reduce the risk of collision events and reduce the insurance premium costs to the fleet owner.

To the extent that future travel conditions are predictable (recurrent congestion in major urban areas is predictable and secondary collision events associated with speed differentials are also recurrent), the present system and method includes a pre-trip planning function delivered via secured communication over the Internet and in-vehicle display of text and graphics and audible output enabling drivers to select a destination by day and time to identify the lowest cost path of travel, where costs may include: time, insurance premium, fuel consumption, and environmental impact. The present system and method determines the onboard pricing algorithms, and uses an iterative process to examine multiple path routes starting with shortest distance and shortest time paths, and calculates total cost of travel and total time of travel so that the driver may select an optimized path. The present system and method is structured so it may be integrated with vehicle OEM and aftermarket route guidance systems.

When statistically significant numbers of vehicles execute the present system and method by participating in real-time insurance pricing, the data collected, transmitted, and compiled provides analysts with the data necessary to undertake a detailed assessment of transportation system performance. Vehicle operations associated with each roadway link (i.e. each polygon in the database) indicate when roadway use demand exceeds capacity and when the roadway capacity is constrained by either inadequate facility design (weave and merge configurations, sight-distance limitations, curvature problems, intersection timing plans, absence of intersection progression, etc.). The present system and method also includes a feature that automatically generates reports for transportation engineers that identify design and operation problems and potential engineering solutions. Using monitored vehicle data, graphical summaries are prepared for each monitored link to summarize the effect of roadway/intersection design and operating parameters on congestion levels, collision frequency, and impact on insurance premium pricing. Using the aforementioned data, periodic reports may be generated which assist transportation decision makers in prioritizing transportation improvement projects. The present method and system may include an application which executes on a portable computing device. The application may be known under the commercial trade name Commute Warrior™.

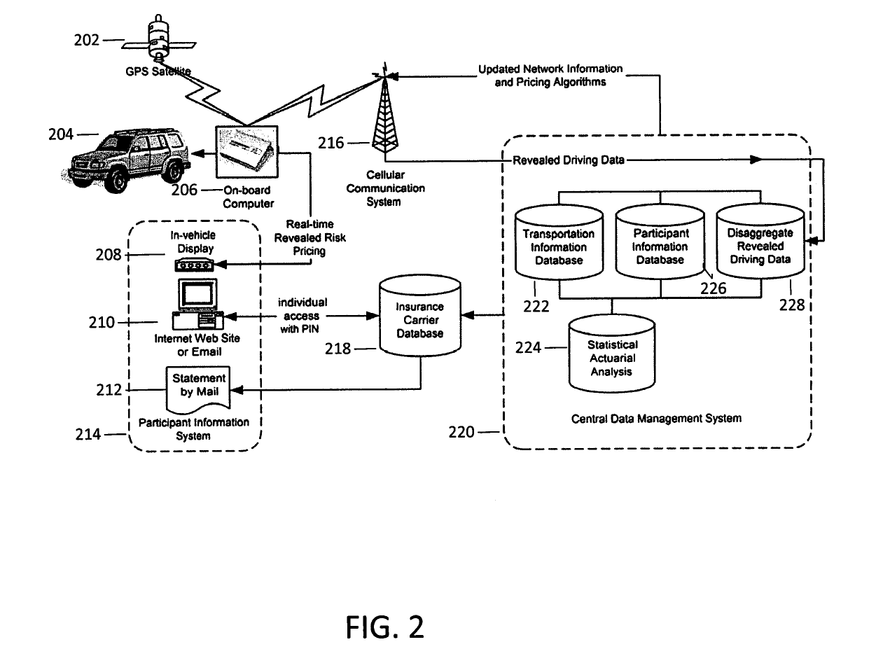

FIG. 2 illustrates a system for determining real-time insurance premium pricing, according to an embodiment of the present disclosure.

Referring to FIG. 2, the system includes a GPS satellite 202, a vehicle 204, an on-board computer 206, a cellular communication system 216, an insurance carrier database, 218, a participant information system 214 and a central data management system 220. The participant information system 214 includes an in-vehicle display, an internet website 210, a statement delivered by mail 212. The central data management system 220 includes a transportation information database 222, a participant (driver or fleet/vehicle owner) information database 226, a disaggregate revealed driving database 228 and a statistical actuarial analysis block 224.

According to an embodiment of the present disclosure, the GPS satellite 202 provides signals to a GPS receiver in the vehicle 204 or on board computer 206 to determine the vehicle location. The vehicle 204 may be owned or operated by the driver or owned by a third party such as a fleet operator which that participates in a real-time insurance premium pricing program as described in the present disclosure. Information provided by sensors and cameras from the vehicle and portable devices of the driver and passengers of the vehicle may be provided to the on board computer 206. The sensor data, still and video images and other information may be uploaded to the central data management system 220 through the cellular communication system 216, a WiFi network or other communications means. Information from the on board computer 206 may be displayed on the in-vehicle display 208 including real time revealed risk pricing information, sensor information, driver behavior coaching information and vehicle location. The in-vehicle display 208 may be mounted in the vehicle 204 or a portable device such as a smartphone or tablet device. The central data management system 220 receives revealed driving data from the on-board computer 206 and stores the revealed driving data in the disaggregate revealed driving database 228. The participant information database 226 stores information associated with the insurance premium pricing program including demographic, collision history, driving record and other data affecting driver quantified risk. The transportation information database 222 stores information associated traffic control systems, roadway polygons and speed limits. The statistical actuarial analysis block 224 may receive information from the transportation information database 222, the participant information database 226 and the disaggregate revealed driving database 228 in order to determine quantified revealed risk, insurance premium pricing algorithms and real-time insurance premium pricing. The central data management system 220 may provide network information and insurance premium pricing algorithms to the on-board computer 206 through the cellular communication system 216 or other communications means. The insurance premium pricing algorithms may be computed on the central data management system 220 or in the on-board computer 206 or portable device such as a smartphone or tablet.

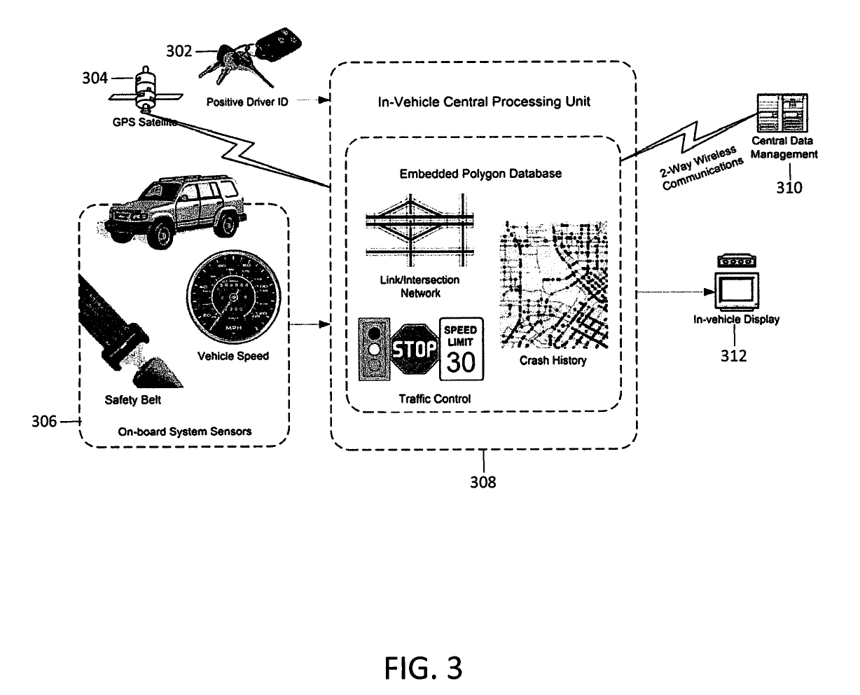

FIG. 3 illustrates a system for determining real-time insurance premium pricing, according to another embodiment of the present disclosure.

Referring to FIG. 3, the system includes a GPS satellite 304, a positive driver identification (ID) 302, on-board system sensors 306, in-vehicle central processing unit 308, a central data management unit 310 and an in-vehicle display 312.

According to an embodiment of the present disclosure, the GPS satellite 304 provides signals to a GPS receiver in the vehicle 204 or in-vehicle central processing unit 308 (which may be included in the on-board computer 206 or a driver or passenger's smartphone) to determine the vehicle location. The on-board system sensors 306 obtains sensor data from sensors in the vehicle including vehicle speed sensors, seat belt sensors, accelerometers, IMU, environmental condition sensors (rain, snow, humidity, temperature) directly form the sensors or through a vehicle interface port such as an OBDII port. The sensor data is provided to the in-vehicle central processing unit 308. The in-vehicle central processing unit 308 also receives imaging data from in vehicle cameras or from smartphones operated in or near the vehicle. The in-vehicle display 312. Information from the in-vehicle central processing unit 308 may be displayed on the in-vehicle display 312 including real time revealed risk pricing information, sensor information, driver behavior coaching information and vehicle location. The in-vehicle display 208 may be mounted in the vehicle or a portable device such as a smartphone or tablet device. The central data management unit 310 may be a server or group of servers accessible through the Internet which sends and receives encrypted data to and from the vehicle using a wireless communication system such as WiFi or cellular. The central data management unit 310 may contain similar data and functions as the central data management system 220.

The present system and method includes travel diary reporting, runs in a background mode with low battery power draw, all days for which trip data were recorded appear in green, page back/forward by month, select any day to view trip journal A daily record of all trips includes: trip date/time, trip duration, trip distance, map icon to play the trip, survey icon to record trip purpose data, trip purpose survey, data links to long-form, Internet-based survey. The present system and method facilitates trip purpose recall, open street map (OSM), pan and zoom features, center and auto-center, slider bar for trip playback, flags—green (start), red (end), trip playback animation, red icon moves with travel, visualize speed and delays, customizable trip data entry, primary trip purpose, drop down box, applicable business activities, short form for app entry, long-form via web interface, includes more complex nested options such as specific customer locations.

According to an embodiment of the present disclosure, the present system and method may include a website interface in which fleet vehicle managers and drivers may access information associated with every trip via. The website login features allow fleet vehicle managers to control access to travel data for vehicles and groups of vehicles, a calendar system allow users to examine trips by date. Monthly vehicle travel summaries, activity logs, daily driver reports, and a wide-variety of automated reports are tailored for each fleet vehicle deployment and uploaded to the website. Drivers and fleet managers may update driver and vehicle data using online forms. Summary Analytical needs define data requirements, accuracy, resolution, acceptable lag, etc., average speeds and travel times are very useful, identify problems and dispatch response units, inform travelers and influence travel decisions, complex analyses such as travel behavior, safety, operations, and emissions require more detailed data, new server and data/mapping systems are ready to support major fleet deployments, extensive experience in automating complex data processing and analysis. The CW app will also integrate the traffic signal sequence encrypted transmission to determine when the traffic signals change.

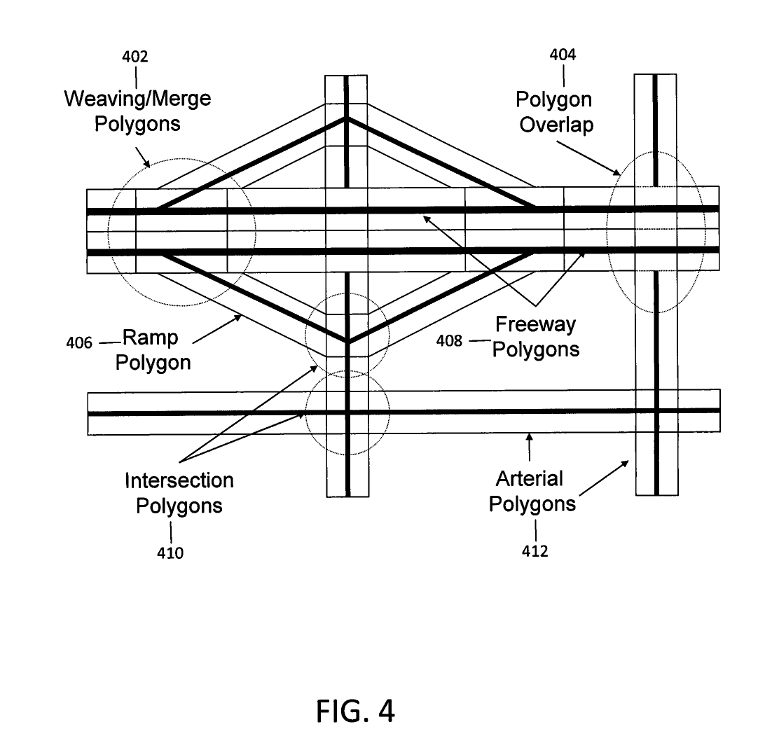

FIG. 4 illustrates roadway polygons, according to an embodiment of the present disclosure.

Referring to FIG. 4, roadway polygons representing a bounded roadway area include weaving/merge polygons 402, polygon overlap 404, ramp polygon 406, freeway polygons 408, intersection polygons 410, and arterial polygons 412.

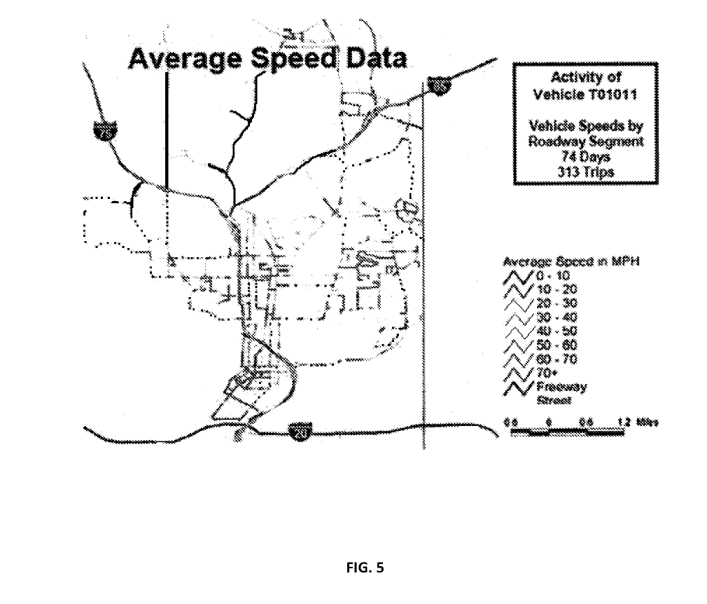

FIG. 5 illustrates a roadway map and average vehicle speeds, according to an embodiment of the present disclosure.

Referring to FIG. 5, a roadway map is illustrated in which average speeds of vehicles traveling on individual roads are indicated in units of miles per hour (MPH).

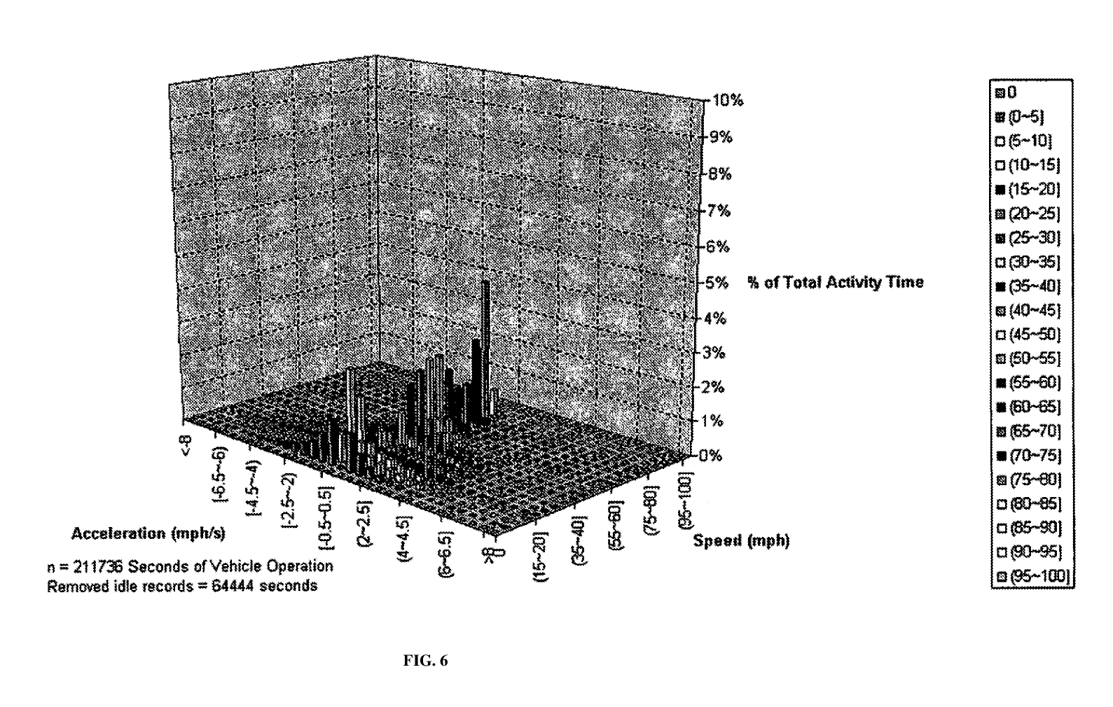

FIG. 6 is a graph illustrating acceleration, speed and activity time of a vehicle, according to an embodiment of the present disclosure.

Referring to FIG. 6, a graph is shown illustrating vehicle operating data associated with a particular driver. The vehicle operating data includes acceleration, speed and activity time of the vehicle.

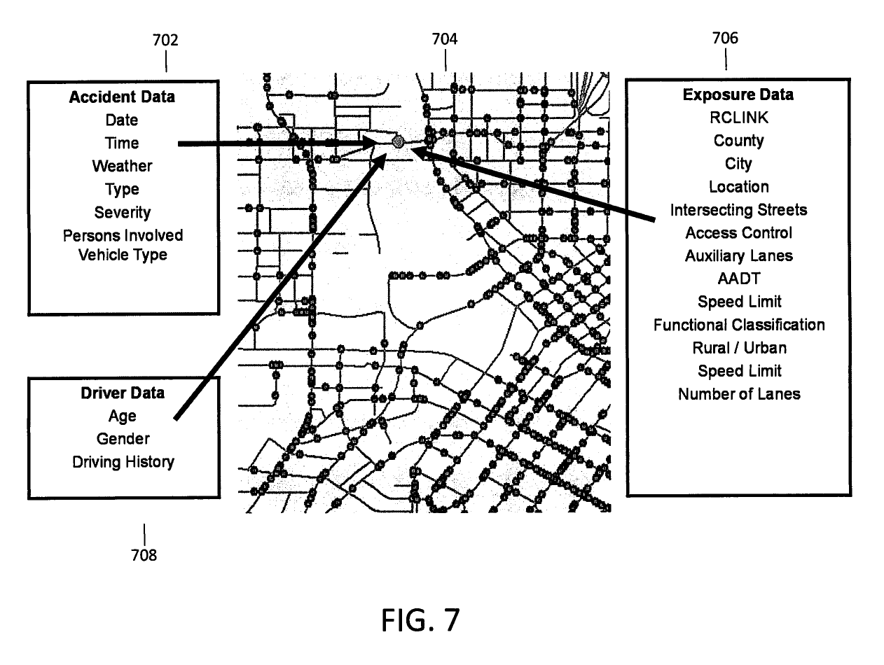

FIG. 7 is a map illustrating accident data, driver data and roadway data, according to an embodiment of the present disclosure.

Referring to FIG. 7, a roadway map 704 is illustrated in which accident data 702 driver data 708 and exposure data 706 is mapped to certain locations on the roadway map 704.

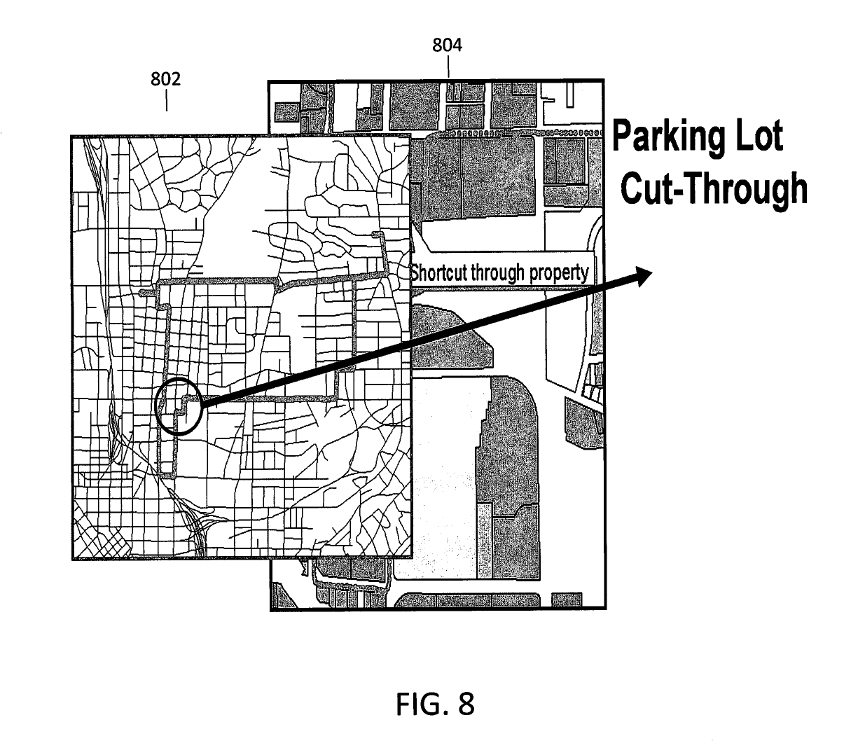

FIG. 8 is a map illustrating alternative driving routes, according to an embodiment of the present disclosure.

Referring to FIG. 8, a roadway map 802 is illustrated in which alternative driving routes are provided to a driver. A shortcut through property map 804 illustrates a travel shortcut through a parking lot.

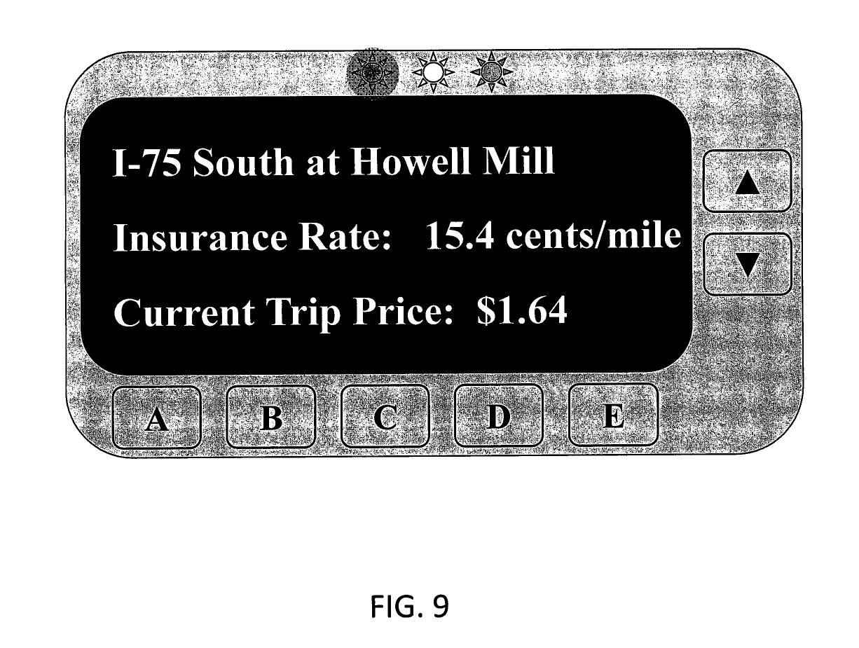

FIG. 9 is a screenshot of a display which displays vehicle location, insurance premium rate and insurance price for a current trip, according to an embodiment of the present disclosure.

Referring to FIG. 9, an example of screenshot of a driver display is shown in which vehicle location is displayed at I-75 South at Howell Mill, an insurance premium rate of 15.5 cents per mile is displayed and an insurance price for a current trip of $1.64 is displayed.

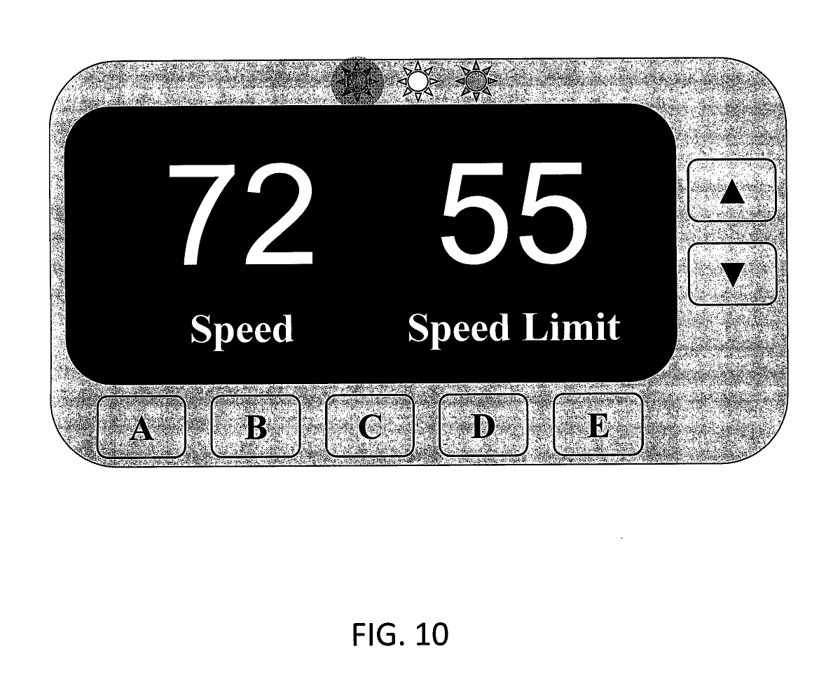

FIG. 10 is screenshot of a display which displays vehicle speed and current vehicle location speed limit, according to an embodiment of the present disclosure.

Referring to FIG. 10, an example of screenshot of a driver display is shown in which a vehicle speed of 72 mile per hour (MPH) is shown and a speed limit of 55 MPH is shown.

While the present disclosure has been particularly shown and described with reference to certain embodiments thereof, it will be understood by those of ordinary skill in the art that various changes in form and details may be made therein without departing from the spirit and scope of the present disclosure as defined by the appended claims and their equivalents.

What is claimed is:

1. A method, comprising:
acquiring data associated with a vehicle, a roadway, an environment and a driver;
encrypting the data;
transmitting the data;
determining a risk based on the data associated with the vehicle, the roadway, the environment and the driver; and
determining an insurance premium price based on the risk, wherein the insurance premium price is in units of price per unit time or price per unit distance.

2. The method of claim 1, wherein the data associated with the roadway is in the form of polygons.

3. The method of claim 1, wherein the risk and the insurance premium price is determined by code executed on a processor located in the vehicle.

4. The method of claim 1, wherein the risk and the insurance premium price is determined by code executed on a processor located in a remote server.

5. The method of claim 1, wherein the data associated with the roadway includes at least one of roadway design, roadway intersection design, operating conditions, average vehicle speed, vehicle speed distribution, vehicle acceleration distribution, acceleration noise, vehicle traffic density, roadway segment length, number of lanes, lane width, shoulder width, roadway curvature, 85th percentile speed, intersection channelization, adjustment of weave and gore areas, traffic control, vehicle capacity and vehicle collision history.

6. The method of claim 1, wherein the data associated with the driver includes at least one of driver demographics, driver's family demographics, driving record, driving experience and accident history.

7. The method of claim 1, wherein the data associated with the vehicle includes at least one of vehicle performance characteristics, vehicle identification number, vehicle operating parameters, age of vehicle, safety equipment in vehicle, number of passengers within vehicle, demographics of passengers within vehicle and engine operating parameters.

8. The method of claim 1, wherein the data associated with the environment includes at least one of weather conditions in the vicinity of the vehicle and still and moving images recorded in or around the vehicle.

9. The method of claim 1, wherein the data associated with the vehicle, the roadway, the environment and the driver are isolated from algorithms used to determine at least one of the risk and the insurance premium price.

10. The method of claim 1, wherein the insurance premium price is provided to the driver or an owner of the vehicle and the determined risk is used to provide information to the driver for modifying driver behaviour.

11. An apparatus, comprising:
a memory; and
a processor configured to:
acquire data associated with a vehicle, a roadway, an environment and a driver,
encrypt the data,
transmit the data,
determine a risk based on the data associated with the vehicle, the roadway, the environment and the driver, and
determine an insurance premium price based on the risk, wherein the insurance premium price is in units of price per unit time or price per unit distance.

12. The apparatus of claim 11, wherein the data associated with the roadway is in the form of polygons.

13. The apparatus of claim 11, wherein the risk and the insurance premium price is determined by code executed on a processor located in the vehicle.

14. The apparatus of claim 11, wherein the risk and the insurance premium price is determined by code executed on a processor located in a remote server.

15. The apparatus of claim 11, wherein the data associated with the roadway includes at least one of roadway design, roadway intersection design, operating conditions, average vehicle speed, vehicle speed distribution, vehicle acceleration distribution, acceleration noise, vehicle traffic density, roadway segment length, number of lanes, lane width, shoulder width, roadway curvature, 85th percentile speed, intersection channelization, adjustment of weave and gore areas, traffic control, vehicle capacity and vehicle collision history.

16. The apparatus of claim 11, wherein the data associated with the driver includes at least one of driver demographics, driver's family demographics, driving record, driving experience and accident history.

17. The apparatus of claim 11, wherein the data associated with the vehicle includes at least one of vehicle performance characteristics, vehicle identification number, vehicle operating parameters, age of vehicle, safety equipment in vehicle, number of passengers within vehicle, demographics of passengers within vehicle and engine operating parameters.

18. The apparatus of claim 11, wherein the data associated with the environment includes at least one of weather conditions in the vicinity of the vehicle and still and moving images recorded in or around the vehicle.

19. The apparatus of claim 11, wherein the data associated with the vehicle, the roadway, the environment and the driver are transmitted using a wireless communications protocol including at least one of second generation (2G), global system for mobile communication (GSM), general packet radio service (GPRS), enhanced data rates for GSM evolution (EDGE), device to device (D2D), machine to machine (M2M), long term evolution (LTE), fifth generation (5G), long term evolution advanced (LTE-A), code division multiple access (CDMA), wideband code division multiple access (WCDMA), universal mobile telecommunications system (UMTS), wireless broadband (WiBro), wireless fidelity (WiFi), vehicle to vehicle, and Bluetooth™.

20. A system, comprising:
a vehicle;
a display device;
a server;
a database; and
a processor configured to:
acquire data associated with the vehicle, a roadway, an environment and a driver,
encrypt the data,
transmit the data,
determine a risk based on the data associated with the vehicle, the roadway, the environment and the driver, and
determine an insurance premium price based on the risk, wherein the insurance premium price is in units of price per unit time or price per unit distance.
